(19) United States
(12) Patent Application Publication
(10) Pub. No.: US 2008/0266641 A1
(43) Pub. Date: Oct. 30, 2008

(54) GPS Anti-Dazzling System and Method for Vehicles

(75) Inventors: Young Jin Yum, Ulsan-city (KR); Sung Hong Hahn, Ulsan-city (KR); Won Kyu Lee, Ulsan-city (KR); Se Myoung Park, Ulsan-city (KR)

Correspondence Address: FITCH EVEN TABIN AND FLANNERY, 120 SOUTH LA SALLE STREET, SUITE 1600, CHICAGO, IL, 60603-3406, US

(73) Assignee: University of Ulsan Foundation for Industry Cooperation, Ulsan-city (KR)

(21) Appl. No.: 12/018,893

(22) Filed: Jan. 24, 2008

(30) Foreign Application Priority Data
Apr. 27, 2007 (KR) 10-2007-0041604

(51) Int. Cl. B60J 3/00

(52) U.S. Cl. 359/246

(57) ABSTRACT

Provided is a system for preventing driver's dazzling caused by illumination lights of headlights of other vehicles at night. The system includes: a windshield polarization plate installed on a windshield of a vehicle, and transmitting a light polarized in a direction determined by an electric signal; a polarization information storing unit storing driveway information on a map, and storing polarization information including the polarization direction of the windshield polarization plate that is set in advance to prevent driver's dazzling according to a location of the driveway and a driving direction; a GPS unit sensing a location of the vehicle on the driveway and the driving direction of the vehicle, and acquiring the polarization information from the polarization information storing unit according to the sensed location and the driving direction; and a polarization controller controlling the polarization direction of the windshield polarization plate according to the polarization information transmitted from the GPS unit.

### CROSS-REFERENCE TO RELATED PATENT APPLICATIONS

This application claims the benefit of Korean Patent Application No. 10-2007-0041604, filed on Apr. 27, 2007, in the Korean Intellectual Property Office, the disclosure of which is incorporated herein in its entirety by reference.

### FIELD OF THE INVENTION

The present invention relates to a global positioning system (GPS) anti-dazzling system and method for vehicles, and more particularly, to an anti-dazzling system and method for vehicles that can prevent driver's dazzling due to headlights of other vehicles by controlling a polarization status of a windshield or a headlight.

### BACKGROUND OF THE INVENTION

When a driver drives at night, illumination lights of vehicles approaching from the front are transmitted to the driver through the windshield or illumination lights of vehicles approaching from the back are transmitted to the driver by being reflected onto the rear view mirror which may dazzle the driver. Thus, the driver may feel uncomfortable, and in some cases, the driver may not see anything for a few seconds, which may cause an accident.

To prevent driver's dazzling, a polarization mirror can be used as the rearview mirror of the vehicle to reduce the light intensity of illumination lights from behind vehicle. However, this method cannot prevent driver's dazzling caused by illumination lights of vehicles approaching from the front. In addition, during daytime driving, the polarization status is maintained even though there is no need for this, and thus, the visual field of the driver is dark.

### SUMMARY OF THE INVENTION

The present invention provides an anti-dazzling system and method for vehicles that can prevent driver's dazzling during night time driving that is caused by illumination lights of vehicles approaching from the front and e illumination lights of vehicles approaching from the back.

The present invention also provides an anti-dazzling system and method for vehicles that do not unnecessarily operate, for example, during daytime driving or when illumination lights of other vehicles are not sensed, so that frontward and backward visual fields of the driver do not become dark.

According to an aspect of the present invention, there is provided a global positioning system (GPS) anti-dazzling system for vehicles, the system including: a windshield polarization plate installed on a windshield of a vehicle, and transmitting a light polarized in a direction determined by an electric signal; a polarization information storing unit storing driveway information on a map, and storing polarization information including the polarization direction of the windshield polarization plate that is set in advance to prevent driver's dazzling according to a location of the driveway and a driving direction; a GPS unit sensing a location and a driving direction of the vehicle, and acquiring the polarization information from the polarization information storing unit according to the sensed location and the driving direction; and a polarization controller controlling the polarization direction of the windshield polarization plate according to the polarization information transmitted from the GPS unit.

According to another aspect of the present invention, there is provided a GPS anti-dazzling method for vehicles, the method including: sensing a location and a driving direction of a vehicle on a driveway by using a GPS; acquiring polarization information from a polarization information storing unit storing road map information and a polarization direction set in advance according to the location and the driving direction of the vehicle for preventing driver's dazzling; and polarizing a windshield polarization plate, which is installed on a windshield of the vehicle and transmits lights polarized in a direction determined by an electric signal, according to the polarization direction stored in the polarization information.

### BRIEF DESCRIPTION OF THE DRAWINGS

The above and other features and advantages of the present invention will become more apparent by describing in detail exemplary embodiments thereof with reference to the attached drawings in which:

FIG. 1 is a schematic view of a vehicle having a global positioning system (GPS) anti-dazzling system according to an embodiment of the present invention;

FIG. 2 is a block diagram of the GPS anti-dazzling system of FIG. 1;

FIG. 3 is a flowchart illustrating a GPS anti-dazzling method for a vehicle according to an embodiment of the present invention; and

FIGS. 4 and 5 are views illustrating an operating status of the GPS anti-dazzling system and method of FIGS. 2 and t3, according to an embodiment of the present invention.

### DETAILED DESCRIPTION OF THE PREFERRED EMBODIMENTS

Hereinafter, a global positioning system (GPS) anti-dazzling system for a vehicle according to an embodiment of the present invention will be described in detail with reference to accompanying drawings.

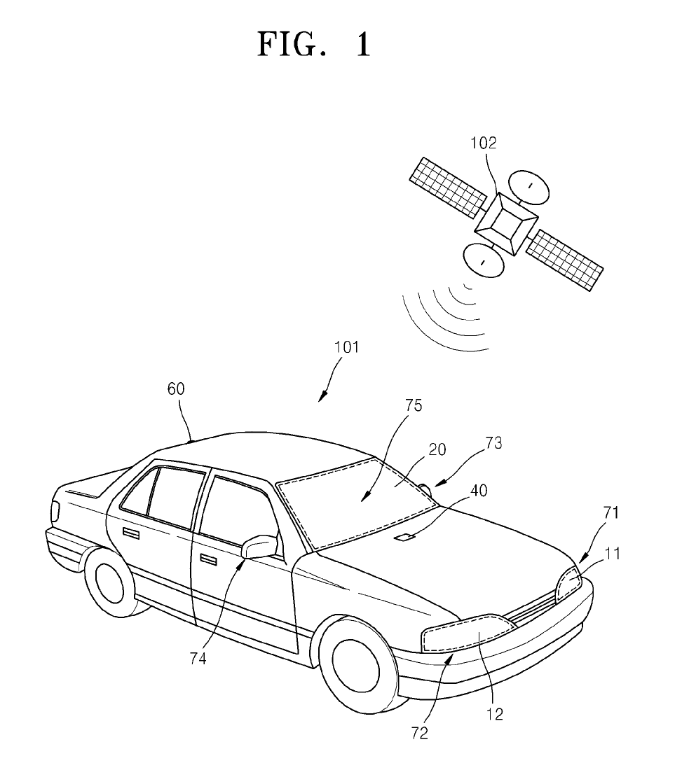

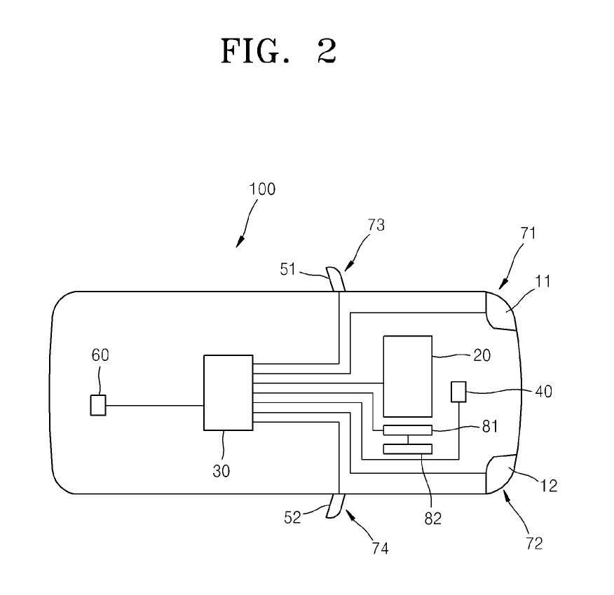

FIG. 1 is a schematic view of a vehicle 101 including a GPS anti-dazzling system 100 (not shown) according to an embodiment of the present invention, and FIG. 2 is a block diagram of the GPS anti-dazzling system 100 of FIG. 1.

Referring to FIGS. 1 and 2, the GPS anti-dazzling system 100 includes a windshield polarization plate 20, headlight polarization plates 11 and 12, a polarization information storing unit 82, a GPS 81, a polarization control unit 30, and a front polarization sensor 40.

The windshield polarization plate 20 and the headlight polarization plates 11 and 12 are formed of polarization plates that transmit light in a polarized state. The polarization plates can be film layers, corpuscle layers, or coating layers formed of an organic layer, an inorganic layer, a ceramic layer, a metal layer, a plastic layer, a dielectric layer, a resin layer, a polymer layer, a liquid crystal layer, or a combination thereof. In addition, the polarization plates are activated polarization plates, that is, polarization plates whose polarization directions can be adjusted by an electric signal transmitted from the outside and the polarized status can be maintained. The polarization plates can be formed in various ways. For example, a plurality of polarization layers including different polarization controlling materials from each other are stacked to form a polarization plate. If necessary, when a voltage is applied to one or more polarization layers from among the plurality of polarization layers, the polarization direction of the polarization plate can be controlled to be aligned to the polarization direction of any polarization layer or the polarization direction obtained by combining the polarization directions of the layers.

The windshield polarization plate 20 is installed on a windshield 75 of the vehicle 101, and filters light so that the light having the same polarization direction as that of the windshield polarization plate 20 can be transmitted through the windshield polarization plate 20.

The headlight polarization plates 11 and 12 are installed on headlights 71 and 72 of the vehicle 101, and filter illumination lights of the headlights so that only illumination lights of the same polarization direction as those of the headlight polarization plates 11 and 12 can be irradiated frontward.

The polarization information storing unit 82 is a memory device storing polarization information. The polarization information include information about driveways on which the vehicle drives, and polarization direction data of the windshield polarization plate 20, which is set in advance to prevent dazzling according to the location of the driveways and driving direction. The polarization direction of the windshield polarization plate 20 included in the polarization information is differently set with respect to lanes in both directions.

The GPS unit 81 senses the location and driving direction of the vehicle 101 on the road by communicating with a satellite 102, and acquires the polarization information from the polarization information storing unit 82 according to the location and driving direction of the vehicle 101 on the road.

The polarization controlling unit 30 generates electric signals to control the polarization directions of the windshield polarization plate 20 and the headlight polarization plates 11 and 12. The polarization controlling unit 30 receives the polarization information from the GPS unit 81, and then, changes the polarization direction of the windshield polarization plate 20 into the polarization direction set by the polarization information. In addition, the polarization controlling unit 30 controls the polarization directions of the headlight polarization plates 11 and 12 to be the same as that of the windshield polarization plate 20, if necessary. That is, the polarization controlling unit 30 controls the polarization direction of the windshield polarization plate 20 to be the same as those of the headlight polarization plates 11 and 12 so that the illumination lights of the headlights are not filtered by the windshield polarization plate 20 but transmitted through the windshield polarization plate 20 when the illumination lights that are radiated to the front portion of the vehicle 101 after being transmitted through the headlight polarization plates 11 and 12 are reflected and returned to the eyes of the driver.

The front polarization sensor 40 is installed on a front portion of the vehicle 101, for example, on the windshield or bonnet of the vehicle 101. The front polarization sensor 40 senses whether another vehicle approaches from the front and whether the illumination lights of the vehicle are polarized by sensing the illumination lights of the front vehicle, and transmits the sensing result to the polarization controlling unit 30.

In response to the sensing result of the front polarization sensor 40, if there is no vehicle approaching from the front, the polarization controlling unit 30 controls the windshield polarization plate 20 and the headlight polarization plates 11 and 12 not be polarized. Accordingly, the driver can see well in the front.

In response to the sensing result of the front polarization sensor 40, if there is another vehicle approaching from the front and the illumination lights of that vehicle are not polarized, the polarization controlling unit 30 receives the polarization information from the GPS unit 81, and changes the polarization direction of the windshield polarization plate 20 to the polarization direction designated by the polarization information. In addition, the polarization controlling unit 30 does not polarizes the headlight polarization plates 11 and 12. Since the windshield polarization plate 20 is polarized to filter the illumination lights of the front vehicle, driver's dazzling can be prevented.

In response to the sensing result of the front polarization sensor 40, if there is another vehicle approaching from the front and the illumination lights of the headlights of that vehicle are polarized by using the GPS anti-dazzling system 100 according to the current embodiment, the polarization direction of the headlight polarization plates 11 and 12 is controlled as follows. That is, the polarization controlling unit 30 receives the polarization information from the GPS unit 81, and controls the polarization directions of the windshield polarization plate 20 and the headlight polarization plates 11 and 12 to be the same with the polarization directions designated by the polarization information. The polarization direction of the headlight polarization plates 11 and 12 is controlled by the polarization controlling unit 30 so as to be the same as that of the windshield polarization plate 20. As described above, the polarization direction of the windshield polarization plate 20 included in the polarization information is set differently for both road directions, and thus, the illumination lights of the front vehicle are filtered by the windshield polarization plate 20 to prevent driver's dazzling.

Meanwhile, the GPS anti-dazzling system 100 according to the current embodiment further includes rear polarization plates 51 and 52, and a rear illumination sensor 60. In addition, the polarization information further includes the polarization direction of the rear polarization plates 51 and 52, which is different from that of the windshield polarization plate 20.

The rear polarization plates 51 and 52 are formed of a polarization plate that transmits light that is polarized in a direction determined by the electric signal transmitted from the outside, like the windshield polarization plate 20 and the headlight polarization plates 11 and 12.

The rear polarization plates 51 and 52 are installed on the rearview mirrors of the vehicle 101. Generally, the rearview mirrors include outside mirrors 73 and 74 and an inside mirror (not shown), and the rear polarization plates 51 and 52 can be installed on both the outside mirrors 73 and 74 and the inside mirror, or on one of the outside mirrors 73 and 74 and the inside mirror. In the current embodiment, the rear polarization plates 51 and 52 are installed on the outside mirrors 73 and 74 only.

The rear illumination sensor 60 senses other vehicles approaching from the back of the vehicle 101 by sensing the illumination lights of rear vehicles, and transmits the sensing result to the polarization controller 30. The rear illumination sensor 60 is installed on the outside mirrors 73 and 74 or on a rear bumper of the vehicle 101.

In response to the sensing result of the rear illumination sensor 60, if no vehicles approach from the back of the vehicle 101, the polarization controller 30 controls the rear polarization plates 51 and 52 not be polarized in any direction.

In response to the sensing result of the rear illumination sensor 60, if other vehicles are approaching from the back of the vehicle 101, the polarization controller 30 controls the polarization direction of the rear polarization plates 51 and 52 according to the polarization information transmitted from the GPS unit 81.

The illumination lights of the vehicle approaching from the back is filtered by the rear polarization plates 51 and 52, and then, reflected by the outside mirrors 73 and 74. Therefore, driver's dazzling is reduced.

If the vehicle approaching from the back also includes a GPS anti-dazzling system 100 of the present invention and the illumination lights of this vehicle are polarized, the polarization direction of the headlight polarization plates 11 and 12 in the rear vehicle is the same as that of the windshield polarization plate 20 of the vehicle 101. In addition, as described above, since the polarization direction of the rear polarization plates 51 and 52 and the polarization direction of the windshield polarization plate 20 are stored to be different from each other, the illumination lights of the headlights of the rear vehicle are filtered by the rear polarization plates 51 and 52. Therefore, driver's dazzling can be prevented.

Hereinafter, a GPS anti-dazzling method according to the present invention will be described with reference to the GPS anti-dazzling system 100 having the above structure.

According to the GPS anti-dazzling method of the present embodiment, night driver's dazzling can be prevented using the above GPS anti-dazzling system.

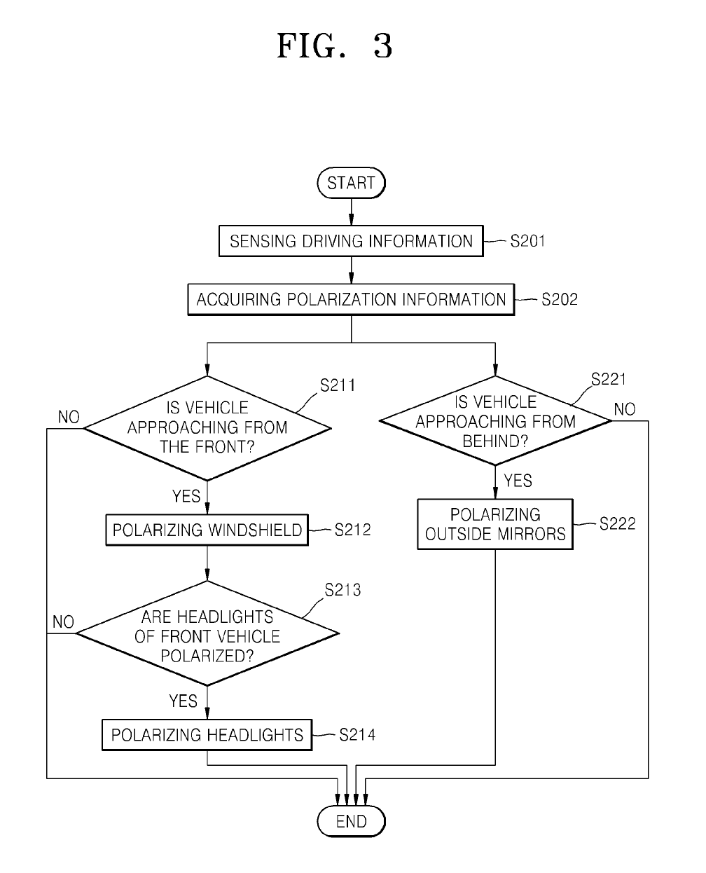

FIG. 3 is a flowchart illustrating the GPS anti-dazzling method according to an embodiment of the present invention.

First, the windshield polarization plate 20, the headlight polarization plates 11 and 12, and the rear polarization plates 51 and 52 of the GPS anti-dazzling system 100 shown in FIGS. 1 and 2 are installed on the windshield 75, the headlights 71 and 72, and the outside mirrors 73 and 74, respectively. In addition, the front polarization sensor 40 and the rear illumination sensor 60 are installed on the vehicle 101, and the polarization information storing unit 82, the GPS unit 81, and the polarization controller 30 are prepared.

In this state, a driving information sensing process (S201) by which the GPS unit 81 senses the location and driving direction of the vehicle 101 on the road is performed.

After the location and driving direction of the vehicle 101 are sensed through the driving information sensing process (S201), the polarization information, that is, the polarization direction of the windshield polarization plate 20 and the polarization direction of the rear polarization plates 51 and 52 according to the current location and the driving direction, are acquired from the polarization information storing unit 82 (S202).

In this state, the illumination lights of other vehicles approaching from the front portion of the vehicle 101 are sensed using the front polarization sensor 40 (S211).

Through the above process S211, if no illumination lights of the vehicle approaching from the front are sensed, the polarization controller 30 controls the windshield polarization plate 20 and the headlight polarization plates 11 and 12 not be polarized in any direction. In this case, the illumination lights radiated from the headlights 71 and 72 are reflected and then transmitted through the windshield 75, and thus, the driver can see the front portion well.

In the above process S211, if other vehicles approaching from the front are sensed, the polarization controller 30 receives the polarization information from the GPS unit 81, and then, polarizes the windshield polarization plate 20 in the direction set by the polarization information. The windshield polarization plate 20 filters the illumination lights of the front vehicle, and thus, driver's dazzling can be prevented.

After performing the processes of S211 and S212, the front polarization sensor 40 senses whether the illumination lights of the front vehicle are polarized or not (S213).

If it is determined that the illumination lights of the vehicle approaching from the front are polarized in the process S213, the polarization controller 30 polarizes the headlight polarization plates 11 and 12 in the same direction as the polarization direction of the windshield polarization plate 20 (S214).

As described above, the polarization direction of the windshield polarization plate 20 varies with the driveways in both directions in the polarization information, and thus, the illumination lights of the vehicle approaching from the front are filtered by the windshield polarization plate 20 and transmitted to the driver, and the illumination lights of the headlights 71 and 72 are polarized and transmitted to the vehicle approaching from the front. Therefore, the driver of the vehicle approaching from the front is not dazzled. In addition, since the polarization direction of the windshield polarization plate 20 and the polarization direction of the headlight polarization plates 11 and 12 are the same, the illumination lights of the headlights of the vehicle 101 are not filtered by the windshield polarization plate 20, and thus, the front view of the driver does not become dark.

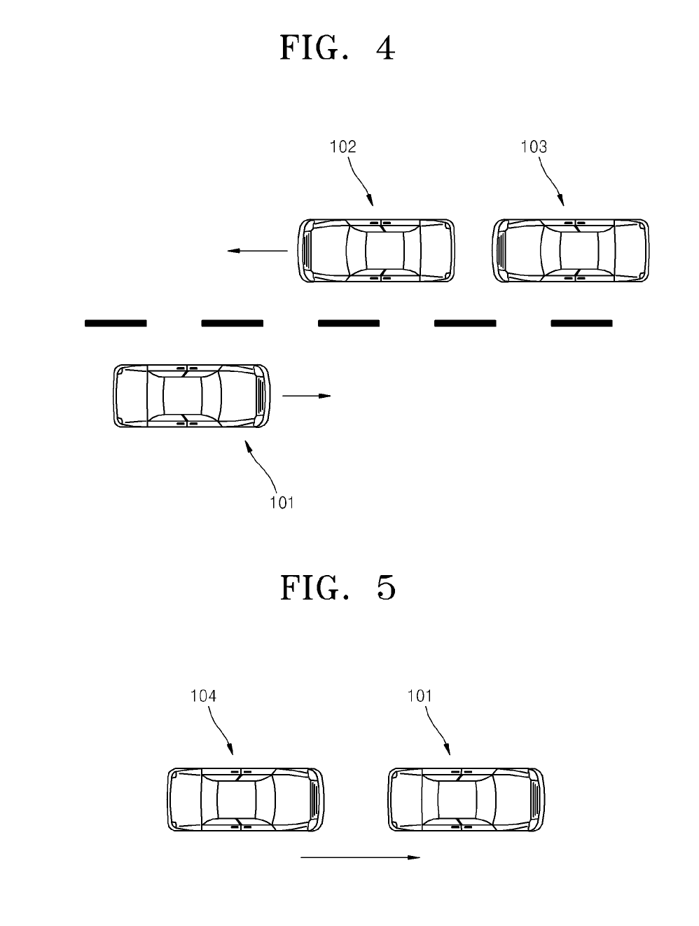

That is, as shown in FIG. 4, in a case where a vehicle 102 approaching from the front does not includes a GPS anti-dazzling system 100 of the present invention and thus radiates illumination lights that are not polarized, the windshield 75 is polarized to filter the illumination lights of the vehicle 102.

In addition, as shown in FIG. 4, in a case where a vehicle 103, behind the vehicle 102, approaching from the front includes a GPS anti-dazzling system 100 of the present invention, the windshield 75 is polarized and the headlights 71 and 72 are also polarized, and thus, the illumination lights of the front vehicle 103 can be filtered and the driver of the front vehicle 103 is not dazzled.

Next, preventing driver's dazzling in a case where a vehicle 104 approaches from the back of the vehicle 101 will be described.

The rear illumination sensor 60 senses the illumination lights of the vehicle 104 that approaches from the back of the vehicle 101 (S221).

If no vehicle approaches from the back of the vehicle 101 in the above process S221, the polarization controller 30 does not polarize the rear polarization plates 51 and 52.

As shown in FIG. 5, if the vehicle 104 approaching from the back of the vehicle 101 in the above process S221, the polarization controller 30 controls the polarization direction of the rear polarization plates 51 and 52 according to the polarization information transmitted from the GPS unit 81 (S222).

When the vehicle 104 approaching from the back radiates illumination lights that is not polarized, the illumination lights of the vehicle 104 are filtered by the rear polarization plates 51 and 52 and reflected to the driver, and thus, the intensity of the lights is reduced and driver's dazzling can be prevented.

On the other hand, if the vehicle 104 approaching from the back includes a GPS anti-dazzling system 100 according to the present invention and radiates illumination lights that are polarized, the polarization direction of the headlights of the vehicle 104 and the polarization direction of the rear polarization plates 51 and 52 are set differently from each other in the polarization information. Therefore, the illumination lights of the vehicle 104 approaching from behind the vehicle 101 is filtered by the rear polarization plates 51 and 52, and thus, the light intensity is reduced and driver's dazzling.

Embodiments of the GPS anti-dazzling system and method for vehicles have been described above, however, the present invention is not limited to the above structures and methods.

For example, the GPS anti-dazzling system 100 for vehicles includes the headlight polarization plates 11 and 12 and the rear polarization plates 51 and 52 in the above description, however, the GPS anti-dazzling system fmay not include the headlight polarization plates 11 and 12 or the rear polarization plates 51 and 52. In this case, the GPS anti-dazzling method does not include the processes of sensing the front polarization (S213), polarizing the headlights (S214), or sensing the rear illumination light (S221).

In addition, the GPS anti-dazzling system 100 includes the front polarization sensor 40 and the rear illumination sensor 60 in the above description, however, it may not include the front polarization sensor 40 or the rear illumination sensor 60. In this case, the GPS anti-dazzling method does not include the processes of sensing the front illumination (S211) and sensing the front polarization (S213), or sensing the rear illumination (S221), and instead, performs the processes of polarizing the windshield, polarizing the headlights, and polarizing the outside mirrors.

In addition, the process of polarizing the headlights (S214) is not performed in a case where the illumination lights of the headlights of the vehicle approaching from the front are not polarized in the process of sensing the front polarization (S213) in the above description; however, the process of polarizing the headlight can be performed without regard to the polarization of the illumination lights of the front vehicle.

In addition, the polarization direction of the rear polarization plates 51 and 52 is controlled according to the polarization information transmitted from the GPS unit 81 in the above description; however, the polarization controller can control the polarization direction to be different from that of the windshield polarization plate without receiving the polarization information from the GPS unit 81.

The GPS anti-dazzling system and method for vehicles according to the present invention prevent driver's dazzling caused by illumination lights of other vehicles during night driving, and thus, can be set to automatically operate at night by the driver or an automatic timer.

According to the present invention, driver's dazzling caused by illumination lights of vehicles approaching from the front, as well as illumination lights of vehicles approaching from behind can be prevented at night.

In addition, the GPS anti-dazzling system of the present invention does not operate unnecessarily, and thus, the driver's convenience is improved.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A global positioning system (GPS) anti-dazzling system for vehicles, the system comprising:
a windshield polarization plate installed on a windshield of a vehicle, and transmitting a light polarized in a direction determined by an electric signal;
a polarization information storing unit storing driveway information on a map, and storing polarization information including the polarization direction of the windshield polarization plate that is set in advance to prevent driver's dazzling according to a location of the driveway and a driving direction;
a GPS unit sensing a location and a driving direction of the vehicle, and acquiring the polarization information from the polarization information storing unit according to the sensed location and the driving direction; and
a polarization controller controlling the polarization direction of the windshield polarization plate according to the polarization information transmitted from the GPS unit.

2. The anti-dazzling system of claim 1, further comprising:
headlight polarization plates installed on headlights of the vehicle, and polarizing illumination lights of the headlights in a direction determined by the electric signal,
wherein the polarization controllers controls the polarization direction of the headlight polarization plates to be the same as the polarization direction of the windshield polarization plate, and the polarization information stored in the polarization information storing unit includes the polarization direction of the windshield polarization plate, which is set differently for both directions of the driveway.

3. The anti-dazzling system of claim 1, further comprising:
a front polarization sensor sensing illumination lights of other vehicles approaching from the front,
wherein when the front polarization sensor senses the illumination lights of the vehicle approaching from the front, and the polarization controller controls the polarization direction of the windshield polarization plate according to the polarization information transmitted from the GPS unit.

4. The anti-dazzling system of claim 2, further comprising:
a front polarization sensor sensing illumination lights of other vehicles approaching from the front,
wherein when the front polarization sensor senses the illumination lights of the vehicle approaching from the front, and the polarization controller controls the polarization direction of the windshield polarization plate according to the polarization information transmitted from the GPS unit.

5. The anti-dazzling system of claim 2, further comprising:
a front polarization sensor sensing the illumination lights of other vehicles approaching from the front and polarization of the illumination lights,
wherein if the illumination lights of the vehicle approaching from the front are determined to be polarized by the front polarization sensor, the polarization controller controls the polarization direction of the windshield polarization plate according to the polarization information transmitted from the GPS unit and controls the polarization of the headlight polarization plates to be the same as that of the windshield polarization plate.

6. The anti-dazzling system of claim 1, further comprising:
rear polarization plates installed on outside mirrors of the vehicle, and transmitting the light polarized in a direction determined by the electric signal,
wherein the polarization controller controls the polarization direction of the rear polarization plates to be different from the polarization direction of the windshield polarization plate.

7. The anti-dazzling system of claim 2, further comprising:
rear polarization plates installed on outside mirrors of the vehicle, and transmitting the light polarized in a direction determined by the electric signal,
wherein the polarization controller controls the polarization direction of the rear polarization plates to be different from the polarization direction of the windshield polarization plate.

8. The anti-dazzling system of claim 6, further comprising:
a rear illumination sensor sensing illumination lights of other vehicles approaching from behind,
wherein if the illumination lights of the vehicle approaching from behind is sensed by the rear illumination sensor, the polarization controller controls the polarization direction of the rear polarization plates to be different from the polarization direction of the windshield polarization plate.

9. The anti-dazzling system of claim 8, wherein the polarization information further includes the polarization direction of the rear polarization plates that is different from the polarization direction of the windshield polarization plate according to the location of the driveway and the driving direction, and the polarization controller controls the polarization directions of the windshield polarization plate and the rear polarization plates according to the polarization information transmitted from the GPS unit.

10. A GPS anti-dazzling method for vehicles, the method comprising:
sensing a location and a driving direction of a vehicle on a driveway by using a GPS;
acquiring polarization information from a polarization information storing unit storing road map information and a polarization direction set in advance according to the location and the driving direction of the vehicle for preventing driver's dazzling; and
polarizing a windshield polarization plate, which is installed on a windshield of the vehicle and transmits lights polarized in a direction determined by an electric signal, according to the polarization direction stored in the polarization information.

11. The GPS anti-dazzling method of claim 10, further comprising:
polarizing illumination lights of headlights in a direction that is the same as the polarization direction of the windshield polarization plate using headlight polarization plates that are installed on the headlights of the vehicle and transmit the illumination lights that are polarized in a direction determined by an electric signal,
wherein the polarization direction of the windshield polarization plate stored in the polarization information storing unit is differently set with respect to both directions of the driveways.

12. The GPS anti-dazzling method of claim 10, further comprising:
sensing illumination lights of other vehicles approaching from the front,
wherein if the illumination lights of other vehicle approaching from the front are sensed, the windshield polarization plate is polarized according to the polarization information.

13. The GPS anti-dazzling method of claim 11, further comprising:
sensing illumination lights of other vehicles approaching from the front,
wherein if the illumination lights of other vehicle approaching from the front are sensed, the windshield polarization plate is polarized according to the polarization information.

14. The GPS anti-dazzling method of claim 11, further comprising:
sensing illumination lights of other vehicles approaching from the front; and
sensing a polarization of the illumination lights, when the illumination light of the vehicle approaching from the front is sensed,
wherein if the illumination lights of the vehicle approaching from the front is sensed, the windshield polarization plate is polarized according to the polarization information, and if the illumination lights of the vehicle approaching from the front are polarized, the headlight polarization plates are polarized.

15. The GPS anti-dazzling method of claim 10, further comprising:
polarizing outside mirrors in a direction different from the polarization direction of the headlight polarization plates so that the polarization direction of rear polarization plates that are installed on the outside mirrors of the vehicle to transmit the light polarized in a direction determined by an electric signal is different from the polarization direction of the headlight polarization plates.

16. The GPS anti-dazzling method of claim 11, further comprising:
polarizing outside mirrors in a direction different from the polarization direction of the headlight polarization plates so that the polarization direction of rear polarization plates that are installed on the outside mirrors of the vehicle to transmit the light polarized in a direction determined by an electric signal is different from the polarization direction of the headlight polarization plates.

17. The anti-dazzling method of claim 15, further comprising:
sensing rear illumination lights of other vehicles approaching from behind,
wherein if the illumination lights of the vehicle approaching from the behind are sensed, the outside mirrors are polarized.

18. The anti-dazzling method of claim 17, wherein the polarization information further includes the polarization direction of the rear polarization plates that is different from the polarization direction of the windshield polarization plate, and the polarizing of the outside mirrors is performed by controlling the polarization direction of the rear polarization plates according to the polarization information.
